(19) United States
(12) Patent Application Publication
(10) Pub. No.: US 2010/0081350 A1
(43) Pub. Date: Apr. 1, 2010

(54) Smooth surface ceramic composites

(75) Inventors: Brock S. McCabe, Monarch Beach, CA (US); David B. Marshall, Thousand Oaks, CA (US)

Correspondence Address: KOPPEL, PATRICK ,HEYBL & DAWSON, PLC, 2815 TOWNSGATE ROAD, SUITE 215, WESTLAKE VILLAGE, CA, 91361-5827, US

(73) Assignee: TELEDYNE SCIENTIFIC & IMAGING, LLC.

(21) Appl. No.: 12/286,660

(22) Filed: Sep. 30, 2008

(51) Int. Cl. B32B 5/02; B29C 39/00

(52) U.S. Cl. 442/127; 264/257; 264/232; 442/178; 442/179

(57) ABSTRACT

A method of making a smooth surfaced, fiber reinforced ceramic matrix composite includes the steps of providing a fiber preform, the preform having a surface containing voids; placing fibers into the voids; coating the preform fibers and the void fibers with a coating material to create a weak interface; and infiltrating the coated fibers with a matrix material to infill the voids and preform, and form strongly bonded networks within the voids. Alternatively, the resulting smooth surfaced, fiber reinforced ceramic matrix composite may include, in addition to the first coating material on the preform fibers and the void fibers and the matrix material within the coated fibers and the preform to infill the voids and preform, a second coating material on the preform fibers and the void fibers, creating a second coating of substantially uniform thickness on the fibers and forming strongly bonded networks within the voids.

### GOVERNMENT RIGHTS

The United States Government has rights in this invention pursuant to a contract (Integrated High Payoff Rocket Propulsion Technology) awarded by the United States Air Force.

### BACKGROUND OF THE INVENTION

This invention is concerned with composite materials designed for applications requiring materials with smooth surfaces.

Composite materials exhibit a variety of advantages for high performance applications, including high temperature strength, superior creep and corrosion resistance, low density, high toughness, and resistance to environmental stresses such as shock, fatigue and physical damage. Because of these characteristics, composites are ideal for replacing metallic or ceramic materials in many engineering applications involving high loads, high temperatures, and aggressive environments.

A variety of manufacturing techniques, such as chemical vapor infiltration (CVI), polymer impregnation/pyrolysis (PIP), liquid silicon infiltration, and slurry impregnation/hot pressing, are employed in the art to fabricate composites. Where a smooth surfaced composite is required, however, these known processes may not be satisfactory. Some components in turbine engines, for example, need smooth surfaces in order to avoid surface roughness, which causes increased drag losses and heat transfer in a hot gas flow path.

When a composite is manufactured by CVI infiltration of SiC (silicon carbide) into a fiber preform, SiC-based matrices are deposited from gaseous reactants onto a heated substrate of SiC fiber preforms. An interphase coated on the fibers helps to control damage and maintain the mechanical behavior of the composite. The texture of the fiber preform, however, is preserved as surface roughness on the finished SiC composite. For thicker composites, this roughness can be removed by machining and recoating with CVI SiC.

This method of reducing the surface roughness, however, can be prohibitively costly for parts with intricate or complex shapes, such as the vanes in a turbine engine. Moreover, the method may not be viable for thin skin components, since it requires removal of part of the outer layer of fiber and it may be necessary, for some applications, to retain all of the fibers to maximize the structural integrity of the composite part.

Another approach to reducing surface roughness is to fill surface depressions using another processing method, such as PIP (Polymer Impregnation Pyrolysis) or MI (Melt Infiltration). The structural properties of matrices produced by these approaches, however, are inferior to those fabricated with CVI SiC. In addition, if the dimensions of the depressions are large (greater than approximately 100 microns), the matrix material produced by a PIP or MI method tends to be susceptible to cracking and to debonding from the underlying CVI SiC material.

Consequently, a need has developed in the art for a composite fabrication process that yields smooth surfaces while maintaining a mechanically superior composite structure yet avoiding excessive cost.

### BRIEF SUMMARY OF THE INVENTION

A method of making a smooth surfaced, fiber reinforced ceramic matrix composite includes the steps of providing a fiber preform, the preform having a surface containing voids; placing fibers into the voids; coating the preform fibers and the void fibers with a coating material to create a weak interface; and infiltrating the coated fibers with a matrix material to infill the voids and preform, and form strongly bonded networks within the voids.

The fiber preform may include interlaced bundles of fiber tows, with the voids between the interlaced bundles. The preform may be a woven preform, a braided preform, or a sewn preform. The preform fibers may be selected to be chemically compatible with the coating material and the matrix material; in particular, the preform fibers may be selected from carbon, silicon carbide, aluminum oxide, and mullite.

The dimensions of the void fibers may be selected to divide the voids into volumes sufficiently small to inhibit cracking and debonding within the composite. This may be accomplished using void fibers that are chopped fibers or whiskers, or by growing void fibers directly on the fiber preform. The void fibers may advantageously be selected to be chemically compatible with the coating material and the matrix material by choosing, for example, fibers of carbon, silicon carbide, aluminum oxide, or mullite.

The coating material may be a weak coating material, as by selecting a material to weakly bond with the preform fibers, with the void fibers, and/or with the infiltration material. The coating material may also be selected to avoid reacting with the preform fibers, with the void fibers, and with the matrix material. Desirable coating materials may be chosen from pyrolytic carbon, BN, monazites, and xenotime.

The matrix material may be selected from refractory carbides and refractory borides, while the infiltration step may be accomplished by infiltrating the coated fibers via chemical vapor infiltration, by infiltrating the coated fibers via infiltration of slurry particles in a polymer precursor, or by infiltrating the coated fibers via an in situ reaction of molten silicon with carbon to form SiC.

The matrix material may be selected from SiC, carbides, borides, oxides, and silicides. Constituents, such as carbides, B-containing compounds, silicides, and glasses, may be added to the infiltration material to improve oxidation resistance.

The method may further include the step of removing material from the surface of the ceramic matrix composite to smooth the surface, as by grinding the surface or chemically polishing the surface. Surface smoothing may also be accomplished by adding, after the step of placing fibers into the voids, the step of defining the boundaries of the void fibers.

A smooth surfaced, fiber reinforced ceramic matrix composite includes, according to the invention, a fiber preform, the preform having a surface containing voids; void fibers in the voids; a coating material on the preform fibers and the void fibers creating a weak interface; and a matrix material within the coated fibers and the preform to infill the voids and preform, and form strongly bonded networks within the voids.

A smooth surfaced, fiber reinforced ceramic matrix composite includes, according to another embodiment of the invention, a fiber preform, the preform having a surface containing voids; void fibers in the voids; a first coating material on the preform fibers and the void fibers, creating a weak interface; a second coating material on the preform fibers and the void fibers, creating a second coating of substantially uniform thickness on the fibers and forming strongly bonded networks within the voids; and a matrix material within the coated fibers and the preform to infill the voids and preform.

### BRIEF DESCRIPTION OF THE DRAWINGS

FIG. 1 is a schematic plan view of a fiber preform.

FIG. 2 is a cross sectional view of the fiber preform shown in FIG. 1.

FIG. 3 is an enlarged cross sectional view showing a portion of the preform in FIG. 2, from the same cross sectional perspective, with fibers placed in the voids.

FIG. 4 shows the preform of FIG. 3 after the preform fibers and the void fibers have been coated.

FIG. 5 shows the preform of FIG. 4 after the coated preform and void fibers are infiltrated with an infiltration material to infill the voids and the preform.

FIG. 6 shows the preform of FIG. 5 after the surface has been treated for further smoothing.

### DETAILED DESCRIPTION OF THE INVENTION

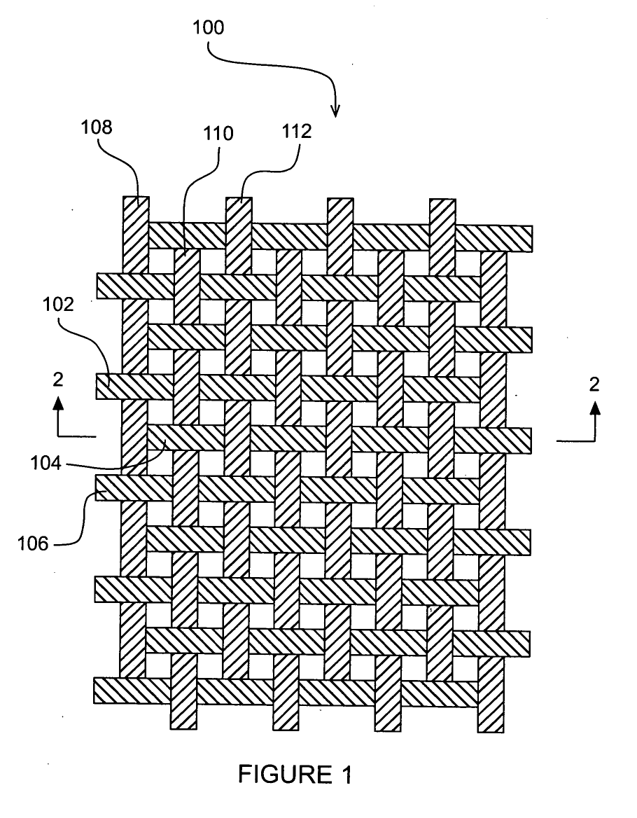

In one embodiment, this invention involves a method of making a smooth surfaced, fiber reinforced ceramic matrix composite that begins by providing a fiber preform, as shown by the fiber preform 100 shown in schematic plan view in FIG. 1. The preform 100 includes horizontal fibers, such as fibers 102, 104, and 106, that are interwoven with vertical fibers, such as fibers 108, 110, and 112.

As those skilled in the art will appreciate, the preform 100 is depicted, for purposes of clarity, in schematic form, with straight, smooth and regular rows and columns of fibers, while an actual preform will typically include substantial irregularities in its dimensions and shapes. Moreover, an actual preform will likely include a much higher number of woven fibers than depicted in FIG. 1.

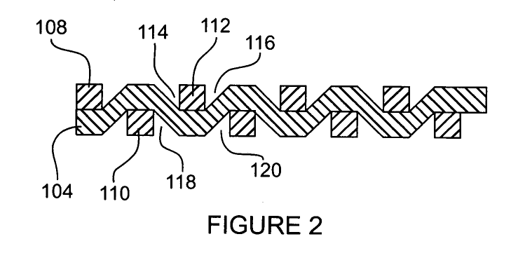

FIG. 2 is a cross sectional view of the fiber preform 100, along the line 2-2 through fiber 104, as shown in FIG. 1. As is evident in the view of FIG. 2, the structure of the preform 100 includes a number of voids in its upper and lower surfaces, such as the voids 114 and 116 in the upper surface and the voids 118 and 120 in the lower surface.

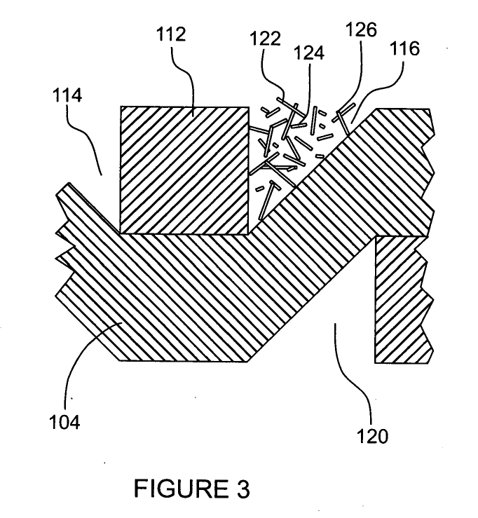

FIG. 3 is an enlarged cross sectional view, showing an enlarged portion of the preform 100 from the same perspective as FIG. 2, including the fibers 104 and 112, and the voids 114, 116, and 120. As shown in FIG. 3, the method proceeds with the step of placing fibers into the surface voids, as shown in FIG. 3 by the fibers, such as, for example, the fibers 122, 124, and 126, placed in the void 116.

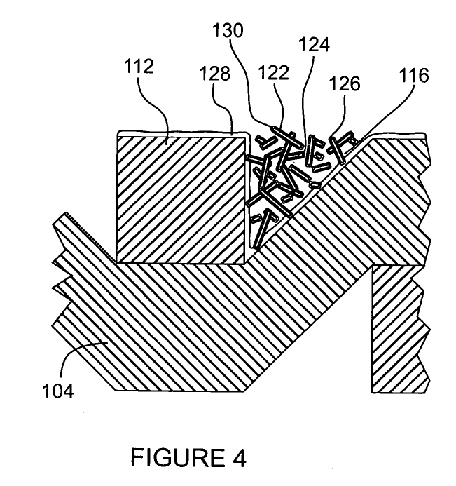

Next, as shown in FIG. 4, the preform fibers and the void fibers are coated with a material to create a weak interface. Thus, the preform fibers 104 and 112 are coated with a coating 128, and void fibers 122, 124 and 126 are coated with a coating surrounding each of them. This coating prevents cracks from crossing between the matrix and fibers, thereby isolating damage in one or the other. This makes the composite tough. The coating material can be weak itself, or it can be weakly bonded with either the fibers or the matrix.

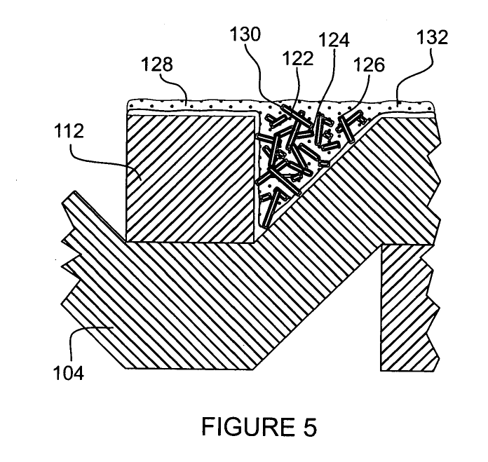

Finally, as depicted in FIG. 5, the coated preform and void fibers are infiltrated with a matrix material 132 to infill the voids and the preform, thereby forming strongly bonded networks within the voids. The network divides the volume of each void into smaller volumes that are reduced to below the critical size for cracking of the matrix material.

In an alternative embodiment, the preform fibers and the void fibers are coated with a first coating material on the preform fibers and the void fibers, creating a weak interface.

Next, a second coating material is applied to the preform fibers and the void fibers, creating a second coating of substantially uniform thickness on the fibers and forming strongly bonded networks within the voids. Finally, the fiber preform is infiltrated with the matrix material that fills the remaining spaces within the networks and in other regions of the fiber preform.

Although the exemplary embodiment of the invention, as illustrated in FIGS. 1-5, utilizes a woven fiber preform, those skilled in the art will appreciate that a variety of different preforms may be used to advantage in the invention. The fiber preform, for example, may include interlaced bundles of fiber tows, with the voids occurring between the interlaced bundles. Other variations may include a fiber preform comprising a braided preform or a sewn preform, as well as filament winding, with large bundles of fibers, and manipulation of fiber tows around pins by hand.

In a more particular embodiment, it may be desirable to select preform fibers that are chemically compatible with the coating material and with the infiltration material. The fibers should also have high strength and remain stable at high temperatures, although the exact qualities will vary with the application. Some particular combinations of fiber materials and coating materials, for example, that are known in the art to be desirable for their compatibility are as follows: carbon and silicon carbide fibers with coatings of carbon and boron nitride; aluminum oxide and mullite fibers with coatings of rare-earth phosphate compounds (monazite and xenotime).

In addition, the dimensions of the void fibers may be selected to divide the voids into volumes sufficiently small to inhibit cracking and debonding within the composite. Various approaches to selecting void fiber dimensions, toward this goal, may be pursued, including utilizing chopped fibers, fiber whiskers, or growing void fibers directly on the fiber preform.

The void fibers, like the preform fibers, may be selected to be chemically compatible with the coating material and with the matrix material. As with the preform fibers, materials that are known in the art to be desirable for their compatibility are as follows: carbon and silicon carbide fibers with coatings of carbon and boron nitride; aluminum oxide and mullite fibers with coatings of rare-earth phosphate compounds (monazite and xenotime).

It may be advantageous to select a coating material that is a weak coating material, such as a coating material that weakly bonds with the preform fibers, with the void fibers, and/or with the infiltration material.

Another property of the coating material that may desirable is to select a coating material that is not reactive with either the preform fibers, the void fibers, or the infiltration material. Particular coating materials that may be advantageous include, for non-oxide fibers and matrices, pyrolytic carbon or boron nitride, and, for oxide fibers and matrices, monazites and xenotime.

As those skilled in the art will appreciate, useful methods of infiltrating the coated fibers include infiltrating the coated fibers via chemical vapor infiltration, infiltrating the coated fibers via an in situ reaction of molten silicon with carbon to form SiC, and infiltrating the coated fibers via infiltration of slurry particles in a liquid precursor. Particular liquid precursors that may be advantageous include polycarbosilane polymers that decompose to leave SiC and solutions containing ions that precipitate to form rare-earth phosphates.

Infiltration materials that may be desirable include refractory carbides, in particular SiC, borides, oxides, and silicides. Moreover, constituents, such as carbides (e.g., HfC), boron-containing compounds (such as B₄C or HfB₂), silicides, and glasses, may be added to the infiltration material to improve oxidation resistance. In the alternative embodiment in which the preform fibers and the void fibers are coated with a first coating material on the preform fibers and the void fibers, then a second coating material is applied to the preform fibers and the void fibers, the infiltration of a second coating material by chemical vapor infiltration produces a thin layer of material on all of the fiber surfaces within the preform and within the voids. This layer is advantageously several times thicker than the diameters of the fibers. In regions where the fibers are touching, the coating forms a continuous layer connecting the fibers, so that the random array of discontinuous fibers/whiskers in the voids forms a rigid three dimensional scaffold that is strongly bonded to the surrounding or underlying fibers tows of the textile preform.

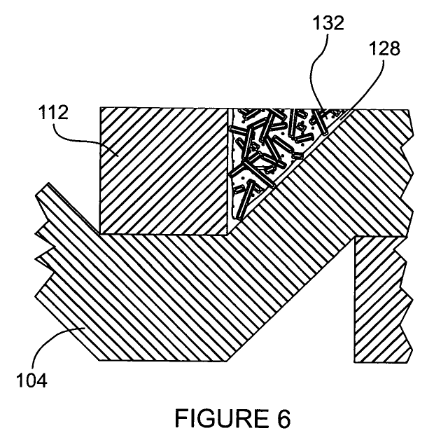

To achieve sufficient surface smoothness for some applications, it may be desirable to further process the composite after the step of infiltrating the fiber preform. Additional surface smoothness, as shown in FIG. 6, can be achieved, for example, by the step of removing material from the surface of the ceramic matrix composite to smooth the surface. Other approaches include grinding the surface or chemically polishing the surface. Alternatively, in a more particular embodiment, after the step of placing fibers into the voids, the step of defining the boundaries of the void fibers to further ensure a smooth surfaced composite can be added. This net shape process defines the outer boundary of the void fiber network by tooling prior to the coating step.

The preferred embodiments of this invention have been illustrated and described above. Modifications and additional embodiments, however, will undoubtedly be apparent to those skilled in the art. Furthermore, equivalent elements may be substituted for those illustrated and described herein, parts or connections might be reversed or otherwise interchanged, and certain features of the invention may be utilized independently of other features. Consequently, the exemplary embodiments should be considered illustrative, rather than inclusive, while the appended claims are more indicative of the full scope of the invention.

1. A method of making a smooth surfaced, fiber reinforced ceramic matrix composite, comprising:
providing a fiber preform, the preform having a surface containing voids;
placing fibers into the voids;
coating the preform fibers and the void fibers with a coating material to create a weak interface; and
infiltrating the coated fibers with a matrix material to infill the voids and preform, and form strongly bonded networks within the voids.

2. The method of claim 1, wherein the fiber preform includes interlaced bundles of fiber tows, with the voids between the interlaced bundles.

3. The method of claim 2, wherein the fiber preform is a woven preform.

4. The method of claim 2, wherein the fiber preform is a braided preform.

5. The method of claim 2, wherein the fiber preform is a sewn preform.

6. The method of claim 1, wherein the preform fibers are selected to be chemically compatible with the coating material and the matrix material.

7. The method of claim 6, wherein the preform fibers are selected from the group consisting of carbon, silicon carbide, aluminum oxide, and mullite.

8. The method of claim 1, wherein the dimensions of the void fibers are selected to divide the voids into volumes sufficiently small to inhibit cracking and debonding within the composite.

9. The method of claim 8, wherein the void fibers are chopped fibers.

10. The method of claim 8, wherein the void fibers are whiskers.

11. The method of claim 8, wherein the step of placing fibers into the voids comprises growing void fibers directly on the fiber preform.

12. The method of claim 1, wherein the void fibers are selected to be chemically compatible with the coating material and the matrix material.

13. The method of claim 1, wherein the void fibers are selected from the group consisting of carbon, silicon carbide, aluminum oxide, and mullite.

14. The method of claim 1, wherein the coating material is a weak coating material.

15. The method of claim 14, wherein the coating material is selected to weakly bond with the preform fibers and with the void fibers.

16. The method of claim 14, wherein the coating material is selected to weakly bond with the matrix material.

17. The method of claim 1, wherein the coating material is selected to avoid reacting with the preform fibers, with the void fibers, and with the matrix material.

18. The method of claim 1, wherein the coating material is selected from the group consisting of pyrolytic carbon, boron nitride, monazites, and xenotime.

19. The method of claim 1, wherein the matrix material is selected from the group consisting of refractory carbides, borides and oxides.

20. The method of claim 1, wherein the step of infiltrating the coated fibers further comprises infiltrating the coated fibers via chemical vapor infiltration.

21. The method of claim 1, wherein the step of infiltrating the coated fibers further comprises infiltrating the coated fibers via infiltration of a slurry comprising particles in a liquid precursor.

22. The method of claim 1, wherein the step of infiltrating the coated fibers further comprises infiltrating the coated fibers via an in situ reaction of molten silicon with carbon to form SiC.

23. The method of claim 1, wherein the matrix material is selected from the group consisting of SiC, carbides, borides, oxides, and silicides.

24. The method of claim 23, wherein constituents are added to the matrix material to improve oxidation resistance.

25. The method of claim 24, wherein the added constituents are selected from the group consisting of carbides, B-containing compounds, silicides, and glasses.

26. The method of claim 1, further comprising the step of removing material from the surface of the ceramic matrix composite to smooth the surface.

27. The method of claim 26, wherein the step of removing material comprises grinding the surface.

28. The method of claim 26, wherein the step of removing material comprises chemically polishing the surface.

29. The method of claim 1, further comprising, after the step of placing fibers into the voids, the step of defining the boundaries of the void fibers to further ensure a smooth surfaced composite.

30. A method of making a smooth surfaced, fiber reinforced ceramic matrix composite, comprising:
providing a fiber preform, the preform having a surface containing voids;
placing fibers into the voids;
coating the preform fibers and the void fibers with a first coating material to create a weak interface;
coating the preform fibers and the void fibers with a second coating material to create a second coating of substantially uniform thickness on the fibers and form strongly bonded networks within the voids; and
infiltrating the networks and coated fibers with a matrix material to infill the voids and preform.

31. A smooth surfaced, fiber reinforced ceramic matrix composite, comprising:
a fiber preform, the preform having a surface containing voids;
void fibers in the voids;
a coating material on the preform fibers and the void fibers creating a weak interface; and
a matrix material within the coated fibers and the preform to infill the voids and preform, and form strongly bonded networks within the voids.

32. The composite of claim 31, wherein the fiber preform includes interlaced bundles of fiber tows, with the voids between the interlaced bundles.

33. The composite of claim 32, wherein the fiber preform is a woven preform.

34. The composite of claim 32, wherein the fiber preform is a braided preform.

35. The composite of claim 32, wherein the fiber preform is a sewn preform.

36. The composite of claim 31, wherein the preform fibers are selected to be chemically compatible with the coating material and the matrix material.

37. The composite of claim 36, wherein the preform fibers are selected from the group consisting of carbon, silicon carbide, aluminum oxide, and mullite.

38. The composite of claim 31, wherein the dimensions of the void fibers are selected to divide the voids into volumes sufficiently small to inhibit cracking and debonding within the composite.

39. The composite of claim 38, wherein the void fibers are chopped fibers.

40. The composite of claim 38, wherein the void fibers are whiskers.

41. The composite of claim 38, wherein the void fibers are grown directly on the fiber preform.

42. The composite of claim 31, wherein the void fibers are selected to be chemically compatible with the coating material and the matrix material.

43. The composite of claim 31, wherein the void fibers are selected from the group consisting of carbon, silicon carbide, aluminum oxide, and mullite.

44. The composite of claim 31, wherein the coating material is a weak coating material.

45. The composite of claim 44, wherein the coating material is selected to weakly bond with the preform fibers and with the void fibers.

46. The composite of claim 44, wherein the coating material is selected to weakly bond with the matrix material.

47. The composite of claim 31, wherein the coating material is selected to avoid reacting with the preform fibers, with the void fibers, and with the matrix material.

48. The composite of claim 31, wherein the coating material is selected from the group consisting of pyrolytic carbon, boron nitride, monazites, and xenotime.

49. The composite of claim 31, wherein the matrix material is selected from the group consisting of refractory carbides, borides and oxides.

50. The composite of claim 31, wherein the matrix material is selected from the group consisting of SiC, carbides, borides, oxides, and silicides.

51. The composite of claim 50, wherein constituents are added to the matrix material to improve oxidation resistance.

52. The composite of claim 51, wherein the added constituents are selected from the group consisting of carbides, B-containing compounds, silicides, and glasses.

53. A smooth surfaced, fiber reinforced ceramic matrix composite, comprising:
a fiber preform, the preform having a surface containing voids;
void fibers in the voids;
a first coating material on the preform fibers and the void fibers, creating a weak interface;
a second coating material on the preform fibers and the void fibers, creating a second coating of substantially uniform thickness on the fibers and forming strongly bonded networks within the voids; and
a matrix material within the coated fibers and the preform to infill the voids and preform.
